(19) United States
(12) Patent Application Publication
(10) Pub. No.: US 2016/0280015 A1
(43) Pub. Date: Sep. 29, 2016

(54) TWO OR MORE PIECE BEAD LOCK SYSTEMS FOR TUBE AND TUBELESS TYRES

(71) Applicant: Vishweshwar Rao JAPALA, Hyderabad (IN)

(72) Inventor: VISHWESHWAR RAO JAPALA, HYDERABAD, OT (IN)

(21) Appl. No.: 15/024,073

(22) PCT Filed: Oct. 11, 2014
(86) PCT No.: PCT/IB2014/065231

§ 371 Date: Mar. 23, 2016

(30) Foreign Application Priority Data
Sep. 25, 2013 (IN) 4353/CHE/2013

(51) Int. Cl. B60C 15/02

(52) U.S. Cl. CPC B60C 15/0213

(57) ABSTRACT

The current invention is related to a two or more piece easy to fit safety device called bead lock when used in combination with tube, tubeless, custom design wheel rim and Tube type or tubeless type tyre, radial or bias provides increased traction and braking when operating under low tyre pressure conditions required for greater traction on rocks, sand, mud snow, loose dirt, or any off-road surface, it improved steering control and minimize the chances of rollover caused by the unseating of the tyre bead in 3 piece lock ring type of wheel rims.

### FIELD OF INVENTION The invention relates to a bead lock safety device for vehicle wheel rims.

### BACKGROUND OF THE INVENTION

The present invention is relates to a 2 or more piece polymer material but not limited to any polymers only, bead lock safety device suitable for vehicle wheels fitted with tube type/tubeless type of Tyres, and is appropriately suitable for 3 piece flat base wheel rims with lock ring type of arrangement. The lock ring types of Wheel rims are more susceptible to disassembly under lower/reduced air pressures or under influence of side impacts unless the tyre beads are restrained in position. A tyre may lose pressure/voluntarily air pressure is reduced to increase the foot print of tyres under such circumstances the tyres traverse freely or uncontrollably becoming twisted and unstable that can cause vehicle to roll over at normal speeds. Single piece bead locks rings made from soft materials like rubber are widely in use and more suitable for bolt on wheel types

The present invention is improvement over existing rubber ring bead lock technology, not only it is stiffer at lower thickness that indirectly reduces the overall weight of bead lock system, but also because of 2 piece configuration easy to assembly inside the tyre, because of the tyre of locking arrangement the whole will function as a single unified ring, that is recyclable, cost effective, stronger in function and easy to assembly by normal tyre technician

A beadlock or bead lock is a mechanical device that secures the bead of a tyre to the wheel Rim. Tyres and wheels are designed so that, when the tyre is inflated, the tyre pressure pushes the bead of the tyre against the inside of the wheel rim so that the tyre stays on the wheel and the two rotate together. In situations where tyre pressure is insufficient to hold the bead of the tyre in place, a bead lock is needed.

There are several styles of bead locks. For 4-wheel drive vehicles, a ring with a number of bolts around the circumference is used to clamp the tyre to the wheel, a different style of bead lock can be used that is similar to an inner tube which is inflated to press the tyre against the wheel and a round circular rubber ring is also used as bead locks.

Bead locking devices were developed to ensure that, when a tyre is run at a low air pressure or zero pressure, the tyre will not run off of the wheel or spin freely on the wheel, rendering the vehicle immobile. Both external and internal bead locking devices are currently used for this purpose. An external bead lock consists of a ring mounted outside of the tyre and rim flange, which is attached to the rim flange with hardware. {See, e.g., FIG. 8 and U.S. Pat. No. 4,505,314). The hardware compresses the tyre bead between the rim flange and the ring. An internal bead lock mounted on a multi-piece wheel, consists of a cylindrical ring wrapped around the circumference of the wheel, which compress both tyre beads into the internal bead lock, locking the assembly together, when the two halves of the wheel are compressed together via the assembly hardware. (See. e.g., FIG. 9 and U.S. Pat. No. 5,271,443). An alternative embodiment of the internal bead lock, is a combined bead lock and run flat as shown in FIG. 10, mounted on a multi-piece wheel. (See, e.g., U.S. Pat. No. 6,076,578). This system follows the same premise as the others outlined above, but with 2 piece arrangement and hard polymer that can withstand side shocks and much more precise suitable for 3 piece flat profile lock ring type wheel rims.

The disclosure of WO/2012/006069 to HUTCHINSON S. A is a improved bead locking apparatus and system is based on the provision of an expandable single and/or dual bead lock device with a bead compression ring that thrusts against the bead(s) of the tyre from the inside and is braced against and via the drop center of the wheel rim and/or an opposing bead compression ring. The ring or rings are caused to press against the tyre bead(s) via mechanical means actuated by a screw driver or similar implement. In single bead lock designs, the said implement can be inserted between the bead and rim on the side of the wheel opposite from that where the compression ring is located.

### OBJECTS OF THE INVENTION

The following description is of the best presently for the purpose of illustrating the general principles of invention and not to be taken in a limited sense

It is an aspect of the present invention to provide a more efficient and Easy to fit, two piece mechanical Bead lock system, suitable for 3 piece flat profile wheel rims with lock ring type locking as defined in one or more of the appended claims and as such, having the capability of accomplishing one or more of the following subsidiary objects that can also takes side on impacts without lock ring imparting the wheel integrity.

An aspect of the present invention is easy to assemble and disassemble when compared to prior technologies.

Another aspect of the present invention is that bead lock position locking helps to maintain wheel balancing intact combined with position locking mechanism

Yet another aspect of the present invention is that the new invented bead locks ends are Rubber capped the current invention has dual advantage of hard structure and soft end that provides required rigidity but also to prevents so called tyre damage.

Yet another aspect of the present invention is light in weight.

Yet another aspect of the present invention is recyclability

Yet another aspect of the present invention is applicable for Tubeless tyres with multi piece wheel rims with lock rings, Split ring wheel rims, Bolt on type wheel rims and Disc Centre type wheel rims.

### SUMMARY OF THE INVENTION

The current invention is also related to a two or more piece easy to fit safety device called bead lock when used in combination with tube, tubeless, custom design wheel rim and Tube type or tubeless type tyre, radial or bias provides increased traction and braking when operating under low tyre pressure conditions required for greater traction on rocks, sand, mud snow, loose dirt, or any off-road surface, it improved steering control and minimize the chances of rollover caused by the unseating of the tyre bead in 3 piece lock ring type flat wheel rims and other multi piece tube type and tubeless versions of tyres.

### DESCRIPTION OF THE INVENTION

The present invention relates to a Easy to fit, two or more piece mechanical Beadlock system, suitable for 3 piece flat wheel rims with lock ring type locking, that requires robust mechanism that can withstand side impacts effectively without crimping inside that may cause the Lock ring to become loose or detached from the wheel rim, exposes the vehicles to safety scare during reduced or low pressure movement required for moving in a particular terrain that requires higher foot print. The ends of such polymer Bead lock are capped with Rubber, Silicone or softer materials that are compatible with soft components of tyres

As the current two or more piece bead lock system also has a position locking system incorporated that prevents rotation of the bead lock that prevents wheel balancing issues.

The current system is more relevant to 3 piece flat wheel rims with Lock ring type where positive locking is lacking, but equally applicable to bolt on split wheel rims and tube type wheel assemblies requiring lateral rigidity

The invention will now be described with reference to the accompanying drawings.

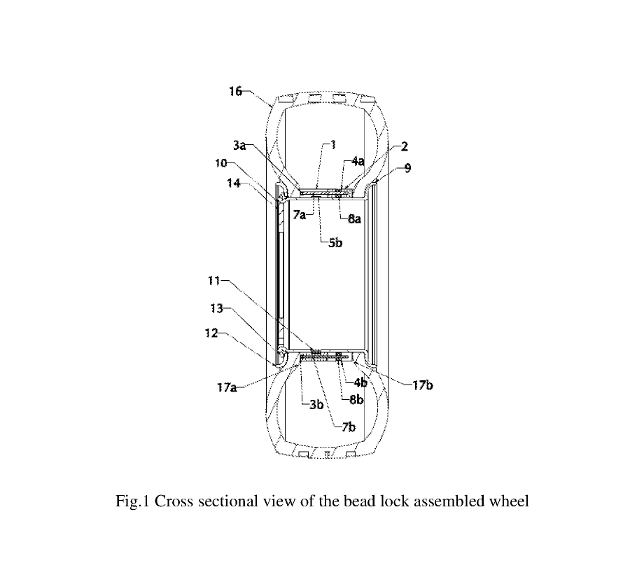

FIG. 1 is a Cross sectional view of the bead lock assembled wheel

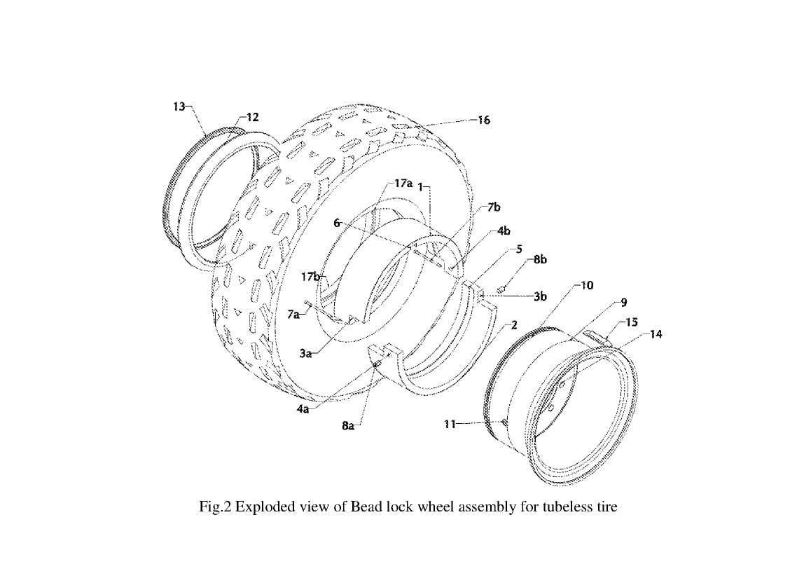

FIG. 2 is a Exploded view of Bead lock wheel assembly for tubeless tyre

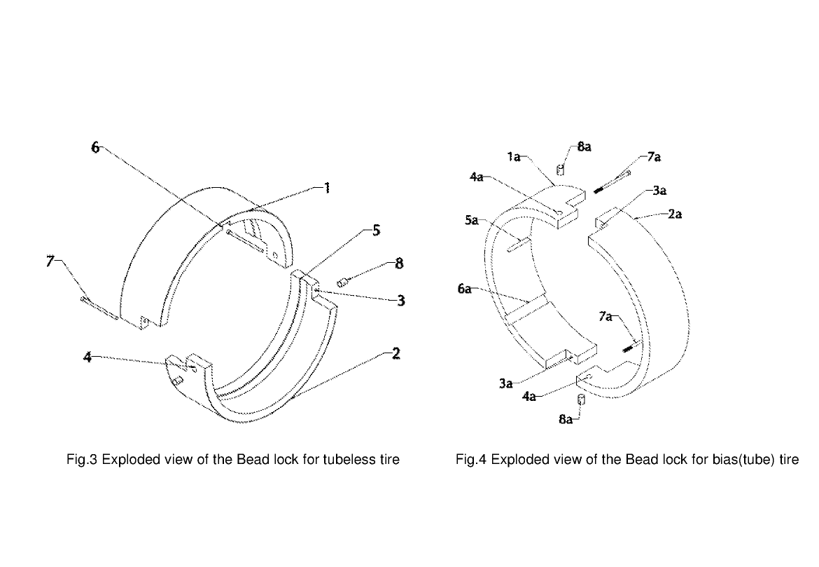

FIG. 3 is a Exploded view of the bead lock for tubeless tyre.

FIG. 4 is a Exploded view of the Bead lock for bias(tube) tyre.

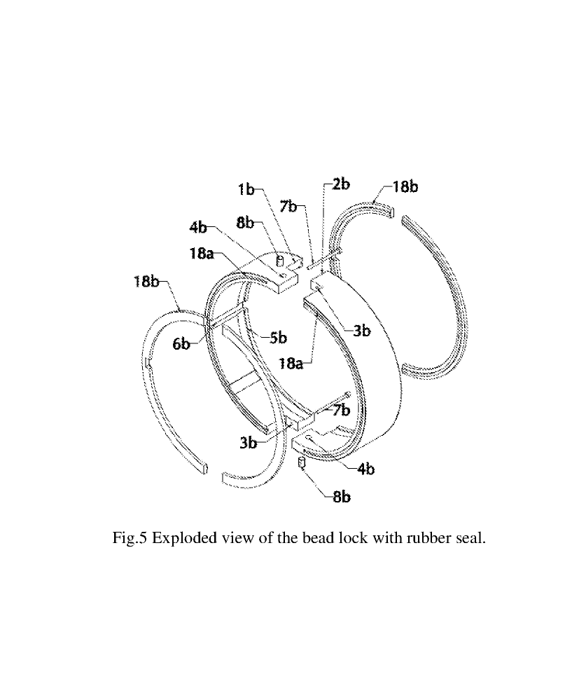

FIG. 5 is a Exploded view of the bead lock with rubber caps.

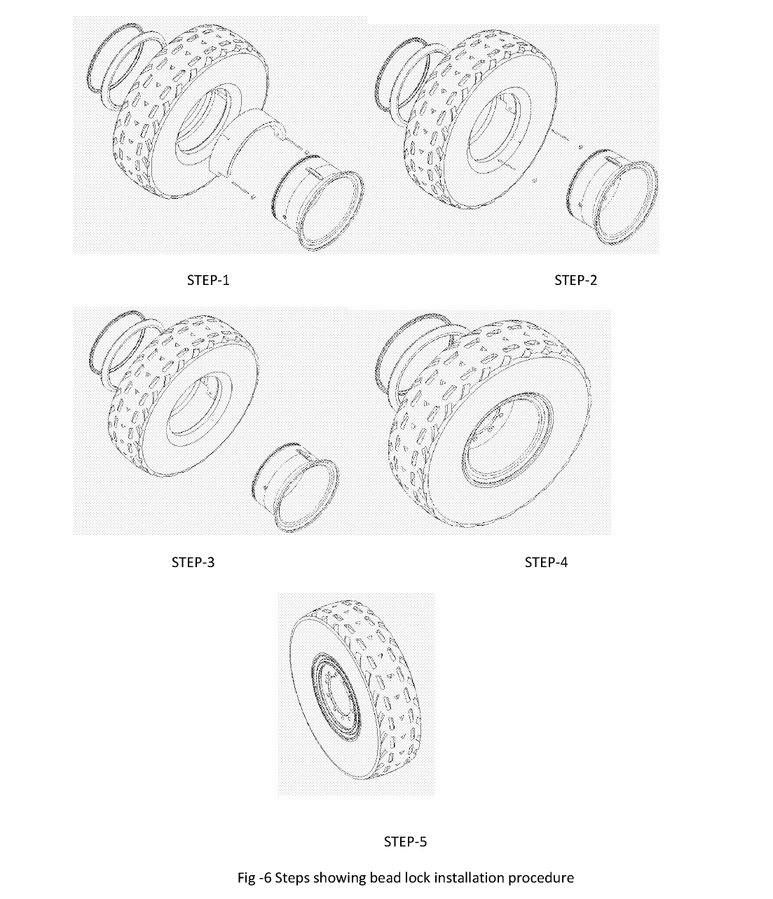

FIG. 6 shows various Steps in installation of bead lock & tyre.

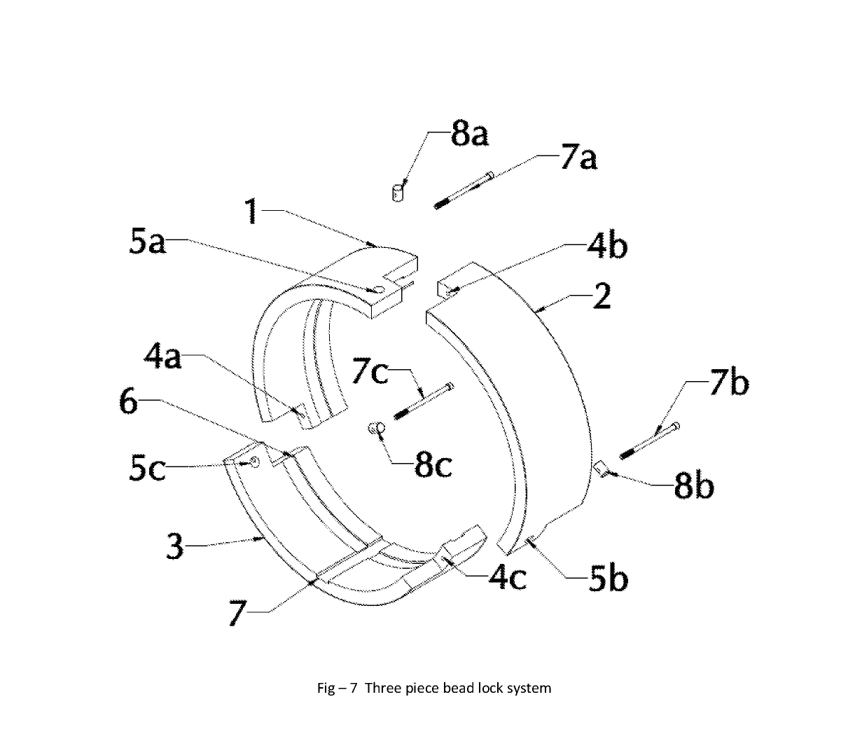

FIG. 7 shows three piece bead lock system.

Referring now to the drawings, from FIG. 1 showing Cross sectional view of Bead lock wheel assembly, constructed in accordance with the teachings of the present invention. Split wheel rim 9 has three main components such as inner wheel 10, air valve slot 11, flange 12, lock ring 13. The inner wheel 10 has centre disk 14 with holes that are used to mount the rim on to axle. Bead lock inner diameter and tyre inner diameter are maintained equally so both tyre and bead lock are inserted on to the rim easily. After inserting tyre and bead lock on to the rim flange 12 and lock ring 13 is assembled to lock the tyre 16, tyre beads 17a, 17b are locked using bead lock segments 1,2.

FIG. 2 shows exploded view of the bead lock wheel assembly

FIG. 3 shows exploded view of the bead lock for tubeless tyre 16. From fig we can read that segment 1 has provided with air valve grooves 5a, 5b weld block groove 6 to prevent rotation of bead lock relative to the rim. Holes 3a, 3b are provided for Allen bolt and holes 4a, 4b are provided for lock nuts to assemble bead lock segments 1 and 2.

FIG. 4 shows an exploded view of bead lock system made for tube bias tyres. In this bead segments 1a, 2a are reduced in width and an external through slot 5a is provided for air valve of tube to pass through it without any obstruction. All the other parameters are same as tubeless bead lock system.

FIG. 5 shows another claimed version of bead lock system which consist of rubber caps 18a, 18b on both sides of the bead lock segments provides following advantages such as:
Outside manual mounting.
Cushioning of tyre.

Referring to the FIG. 6, the procedure adopted in mounting two piece bead lock segment is as follows;
Step 1: Bead lock segment 1 is inserted into the tire 16.
Step 2: Bead lock segment 2 is inserted into the tire 16 such that to join with segment 1.
Step 3: Now the two segments are assembled using nuts(7a,7b) and bolts (8a,8b) to form a ring like structure.
Step 4: Now the air seal 15a is assembled on to the wheel rim 10.
Step 5: Now the rim 10 is fitted into tire 16 by sliding against the bead lock by positioning the weld block modification to constraint rotational movement of the bead lock.
Step 6: Now the second air seal 15b is positioned on to the rim 10.
Step 7: At last flang 12 and lock ring 13 are mounted on to the rim respectively in their positions.

FIG. 7 shows a bead lock system have more than two pieces.

1. A two or more piece bead lock system for tube and tubeless tyres, bead lock system comprising:
a. two or more pieces form into a bead lock ring
b. Split wheel rim 9 has three main components such as inner wheel 10, air valve slot 11, flange 12, lock ring 13;
c. The inner wheel 10 has centre disk 14 with holes that are used to mount the rim on to axle;
d. Rubber Air seals 15a and 15b are used to prevent the air leakage.
e. Bead lock inner diameter and tyre inner diameter are maintained equally so both tyre and bead lock are inserted on to the rim easily;
f. After inserting tyre and bead lock on to the rim flange 12 and lock ring 13 is assembled to lock the tyre 16, tyre beads 17a, 17b are locked using bead lock segments 1,2.

2. A two or more piece bead lock system for tube and tubeless tyres, wherein segment 1 has provided with air valve grooves 5a, 5b weld block called position lock 6 to prevent rotation of bead lock relative to the rim.

3. A two or more piece bead lock system for tube and tubeless tyres, wherein holes 3a, 3b are provided for Allen bolt and holes 4a, 4b are provided for lock nuts to assemble bead lock segments 1 and 2.

4. A two or more piece bead lock system for tube type and tubeless tyres, wherein bead segments 1 a, 2a are reduced in width and an external through slot 5a is provided for air valve of tube to pass through it without any obstruction.

5. A two or more piece bead lock system for tube and tubeless tyres, wherein bead lock system which consist of rubber caps 18b on both sides of the bead lock segments 1b,2b.

6. A two or more piece bead lock system for tube and tubeless tyres, wherein the ends of such polymer bead lock is capped with Rubber, Silicone or softer materials that are compatible with Rubber tyres.
